(19) United States
(12) Patent Application Publication
(10) Pub. No.: US 2016/0300247 A1
(43) Pub. Date: Oct. 13, 2016

(54) SALES DATA PROCESSING APPARATUS, SERVER AND METHOD FOR ACQUIRING ATTRIBUTE INFORMATION

(71) Applicant: TOSHIBA TEC KABUSHIKI KAISHA, Tokyo (JP)

(72) Inventor: Hiroshi Nishikawa, Izunokuni (JP)

(21) Appl. No.: 15/091,654

(22) Filed: Apr. 6, 2016

(30) Foreign Application Priority Data
Apr. 7, 2015 (JP) 2015-078628

(51) Int. Cl. G06Q 30/02; G06K 9/00; H04N 7/18

(52) U.S. Cl. CPC G06Q 30/0201; H04N 7/181; G06K 9/00268; G06K 9/00288

(57) ABSTRACT

A sales data processing apparatus comprises a commodity information storage module which stores commodity information of a commodity processed in a transaction; a first attribute storage module which stores, in a case in which a face by means of which an attribute of a customer who purchases the commodity can be determined can be detected according to images captured by a camera, attribute information indicating the attribute determined according to face image information of the detected face in association with the commodity information; a captured image storage module which stores the captured images; a sending module which sends the commodity information stored by the commodity information storage module and the captured images stored by the captured image storage module to a server in a case in which the face by means of which the attribute of the customer who purchases the commodity can be determined cannot be detected according to the captured images; and a second attribute storage module which stores the attribute information indicating the attribute which is determined according to the face image information of the customer sent from the server that extracts a customer according to the sent commodity information in association with the commodity information.

### CROSS-REFERENCE TO RELATED APPLICATION

This application is based upon and claims the benefit of priority from Japanese Patent Application No. 2015-078628, filed Apr. 7, 2015, the entire contents of which are incorporated herein by reference.

### FIELD

Embodiments described herein relate generally to a sales data processing apparatus, a server and a method for acquiring attribute information.

### BACKGROUND

In a store such as a convenience store, to analyze clientele and the sales of commodities, there is a case in which attribute information such as gender, age bracket and the like of a customer who purchases commodities in the store is acquired. The attribute information of the customer is acquired by analyzing the image of the customer captured by a camera arranged on a POS (Point of Sales) terminal or a ceiling.

Incidentally, to acquire the attribute information according to the image of the customer, it is needed to photograph the face of the customer from the front of the customer. However, there is a possibility that the attribute information of the customer cannot be acquired in a case in which the customer does not directly face the camera or in a case in which the customer directly faces the camera but wears a mask or hat.

### DESCRIPTION OF THE DRAWINGS

FIG. 1 is a plan view schematically illustrating the arrangement of each apparatus in a store;

FIG. 2 is a perspective view illustrating the appearance of a POS terminal at a customer side according to an embodiment;

FIG. 3 is a block diagram illustrating the hardware structure of the POS terminal;

FIG. 4 is a memory map exemplifying a face master file of the POS terminal;

FIG. 5 is a block diagram illustrating the hardware structure of a camera server;

FIG. 6 is a memory map exemplifying an area storage section of the camera server;

FIG. 7 is a functional block diagram illustrating functional components of the POS terminal;

FIG. 8 is a flowchart illustrating the procedures of a control processing carried out by the POS terminal;

FIG. 9 is a flowchart illustrating the procedures of a control processing carried out by the POS terminal;

FIG. 10 is a flowchart illustrating the procedures of a control processing carried out by the POS terminal;

FIG. 11 is a functional block diagram illustrating functional components of the camera server;

FIG. 12 is a flowchart illustrating the procedures of a control processing carried out by the camera server; and

FIG. 13 is a diagram schematically exemplifying a face clustering of the camera server.

### DETAILED DESCRIPTION

In accordance with an embodiment, a sales data processing apparatus comprises a commodity information storage module configured to store commodity information of a commodity processed in a transaction in a storage section; a first attribute storage module configured to store, in a case in which a face by means of which an attribute of a customer who purchases the commodity can be determined can be detected according to images captured by a camera, attribute information indicating the attribute determined according to face image information of the detected face in the storage section in association with the commodity information; a captured image storage module configured to store the captured images; a sending module configured to send the commodity information stored by the commodity information storage module and the captured images stored by the captured image storage module to a server in a case in which the face by means of which the attribute of the customer who purchases the commodity can be determined cannot be detected according to the captured images; and a second attribute storage module configured to store the attribute information indicating the attribute which is determined according to the face image information of the customer sent from the server that extracts a customer according to the sent commodity information and the captured images in the storage section in association with the commodity information.

A server according to the embodiment comprises an image storage module configured to store image information of customers who pass through areas photographed by cameras respectively installed in a plurality of areas where commodities are displayed; a storage section configured to store each of the plural areas in association with commodity information of each commodity displayed in the area; a receiving module configured to receive the commodity information of the commodity processed by a sales data processing apparatus in a transaction and image capturing information obtained by photographing a customer who purchases the commodity; an area selection module configured to select each area stored in the storage section containing the received commodity information; a face image extraction module configured to extract face image information of a customer photographed in most areas according to the captured images and face images of the customer captured in the area identified from the image information of the selected area; and a sending module configured to send the extracted face image information to the sales data processing apparatus.

According to the embodiment, by controlling a sales data processing apparatus through a computer, a method for acquiring attribute information causes the computer to function as a commodity information storage module configured to store commodity information of a commodity processed in a transaction in a storage section; a first attribute storage module configured to store, in a case in which a face by means of which an attribute of a customer who purchases the commodity can be determined can be detected according to an image captured by a camera, attribute information indicating the attribute determined according to face image information of the detected face in the storage section in association with the commodity information; a captured image storage module configured to store the captured image; a sending module configured to send the commodity information stored by the commodity information storage module and the captured image stored by the captured image storage module to a server in a case in which the face by means of which the attribute of the customer who purchases the commodity can be determined cannot be detected according to the captured image; and a second attribute storage module configured to store the attribute information indicating the attribute which is determined according to the face image information of the customer sent from the server that extracts a customer according to the sent commodity information and the captured image in the storage section in association with the commodity information.

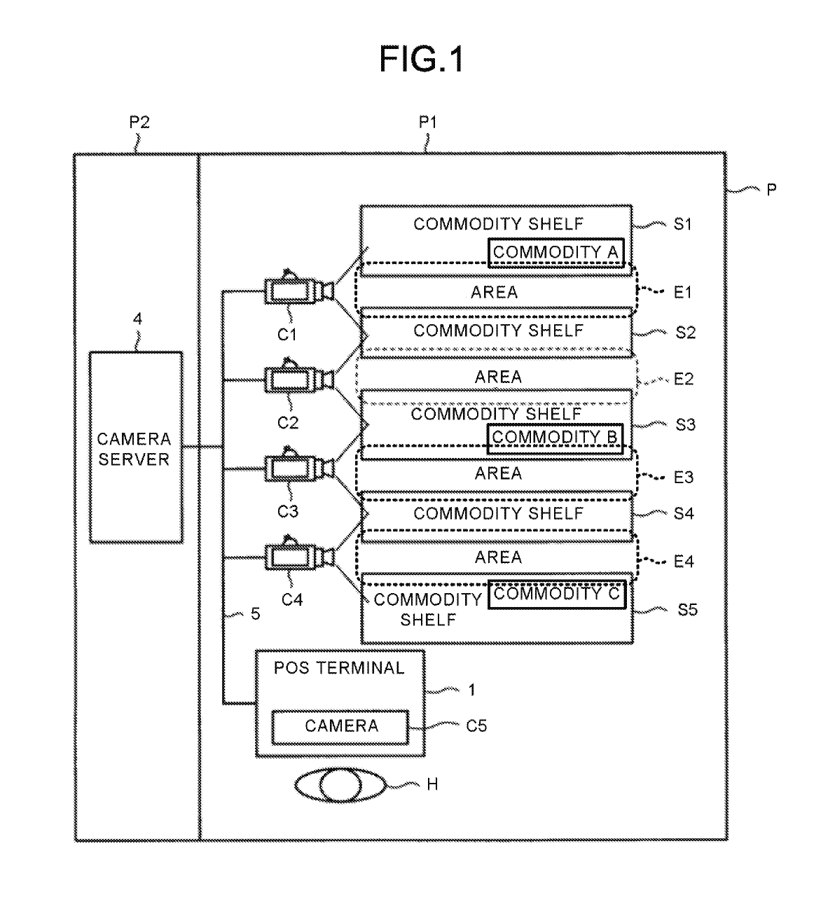

The sales data processing apparatus, the server and the method for acquiring attribute information according to the embodiment are described below in detail with reference to FIG. 1-FIG. 13. In the embodiment, a POS (Point Of Sales) terminal is used as the sales data processing apparatus. Further, in the embodiment, a camera server is described as the server. The embodiment described below is not to be construed as limiting the present invention.

FIG. 1 is a plan view schematically illustrating a state in which a POS terminal 1 and a camera server 4 are arranged in a store according to the embodiment. In FIG. 1, there is a sales area P1 where commodities are sold and an office area P2 serving as a back office in a store P. A plurality of rows of shelves S (S1-S5), a plurality of cameras C (C1-C5) and a POS terminal 1 are arranged in the sales area P1. A reference sign ‘S’ is used to represent the shelves collectively while reference signs ‘S1-S5’ are used to represent the shelves separately. A reference sign ‘C’ is used to represent the cameras collectively while reference signs ‘C1-C5’ are used to represent the cameras separately. The camera server 4 is installed in the office area P2.

The POS terminal 1, the cameras C1-C4 and the camera server 4 are electrically connected with one another via a communication line 5. The camera C5 is built in the POS terminal 1.

Each shelf S is segmented into a plurality of sections in each of which a plurality of commodities is displayed. Areas E (E1-E4) are separately arranged between the shelves S. A reference sign ‘E’ is used to represent the areas collectively while reference signs ‘E1-E4’ are used to represent the areas separately. The area E is arranged between the shelves S enough for the customer to pass through. The customer can glance over the commodities displayed on the shelf S or take a commodity down from the shelf S and place the commodity into a shopping basket or shopping cart to purchase it while passing through the area E.

The cameras C1-C4 are installed on the ceiling of the sales area P1 of the store P. The cameras C1-C4 arranged on the ceiling face the areas E respectively. The cameras C1-C4 each consisting of, for example, a CCD, capture continuous still images or dynamic images (referred to as ‘images’ collectively) of a photographed object such as a customer H. In the embodiment, the cameras C1-C4 each capture 10 continuous still images of the customer H who passes through the area E within one second. The camera C1 captures the images of a customer who passes through the area E1. The camera C2 captures the images of a customer who passes through the area E2. The camera C3 captures the images of a customer who passes through the area E3. The camera C4 captures the images of a customer who passes through the area E4. The images captured by the cameras C1-C4 are sent to the camera server 4 via the communication line 5.

The POS terminal 1 carries out a sales registration processing relating to sales of commodities sold in the store. An operator CH serving as a store clerk operates the POS terminal 1 to cause the POS terminal 1 to carry out a sales registration processing and a settlement processing for the sold commodities. The sales registration processing refers to a processing of optically reading a code symbol, for example, a barcode, attached to a sold commodity, inputting a commodity code and displaying the commodity name and the price (commodity information) of the commodity read according to the input commodity code while storing the commodity information in a buffer. The settlement processing refers to a processing of displaying a total amount relating to the transaction according to the commodity information stored in the buffer along with the execution of the sales registration processing and calculating a change amount according to a deposit amount prepaid by a customer and displaying the calculated change amount, a processing of instructing a change dispensing machine to issue change and a processing of issuing a receipt on which the commodity information and the settlement information (the total amount, the deposit amount and the change amount) are printed. Further, the combination of the sales registration processing and the settlement processing is referred to as a transaction processing.

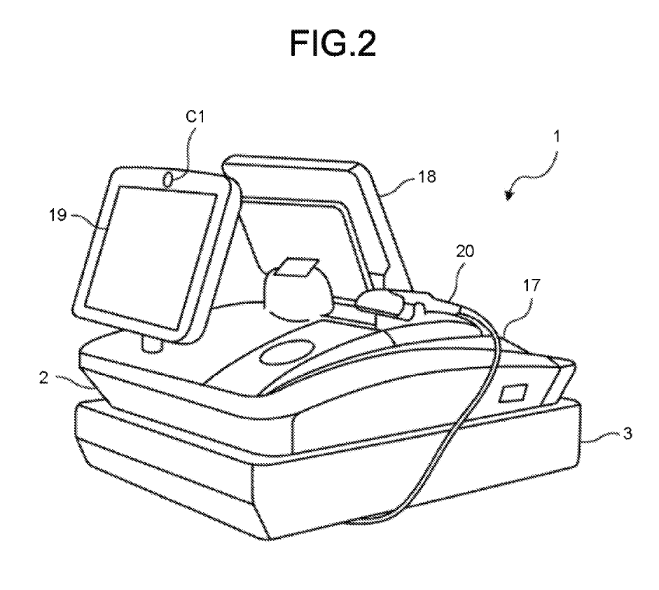

The camera C5 is arranged on a display for customer (refer to FIG. 2) of the POS terminal 1 facing a customer who purchases a commodity. The camera C5 captures images of a customer H who purchases a commodity (that is, a customer H who executes a transaction). In the embodiment, the camera C5 captures, for example, 10 continuous still images of the customer H within one second.

FIG. 2 is a perspective view illustrating the appearance of the POS terminal 1 at the side of the customer H according to the embodiment. In FIG. 2, the POS terminal 1 includes a main body 2 and a cash box 3. The cash box 3 with a drawer stores cash such as bills and coins and marketable securities such as a gift voucher received from the customer H and change to be dispensed to the customer H.

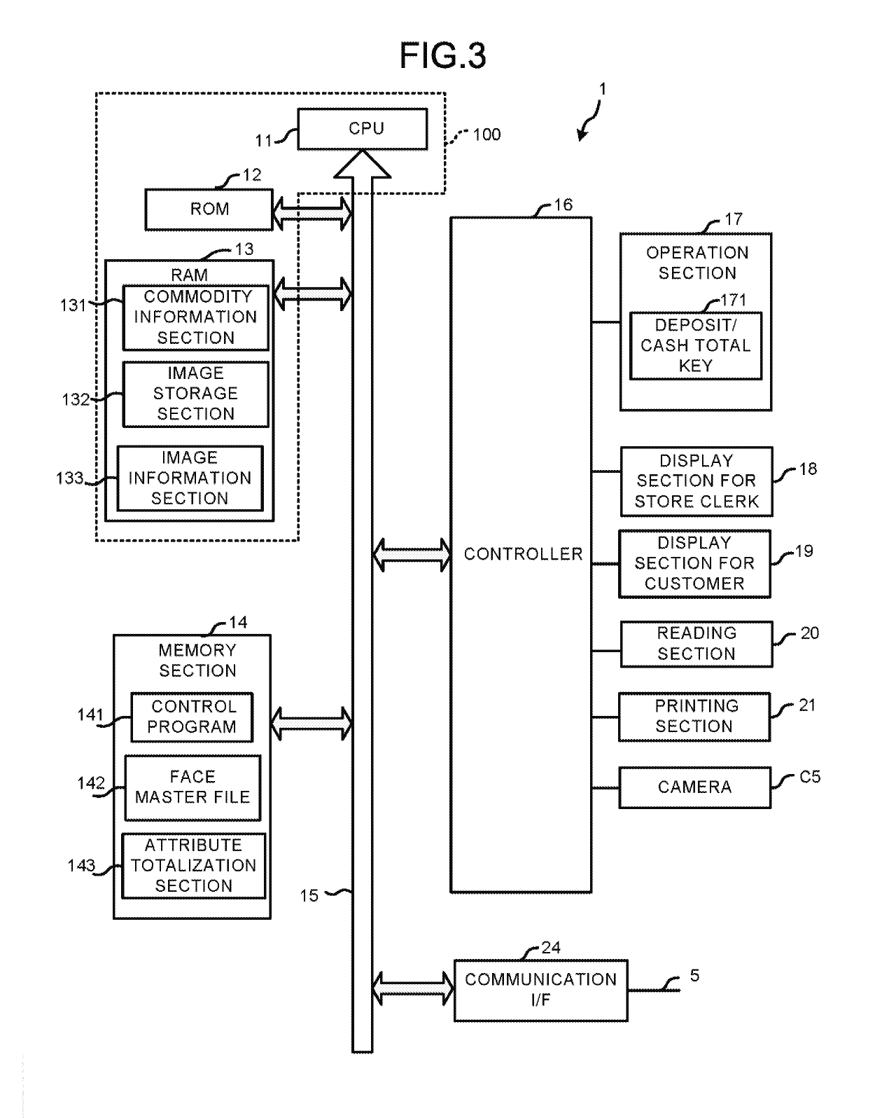

An operation section 17 (e.g. a keyboard) for inputting information, a display section 18 for store clerk, e.g., a liquid crystal display, which displays information to the operator and a display section 19 for customer, e.g., a liquid crystal display, which displays information to the customer H are arranged on the main body 2. Further, the main body 2 is provided with a reading section 20 for reading a code symbol, for example, a barcode or a two-dimensional code, attached to a commodity. The reading section 20 reads and inputs a barcode or a two-dimensional code attached to a commodity with the use of a CCD line sensor. Further, a control section 100 (refer to FIG. 3) of the POS terminal 1 and a printing section 21 for printing commodity information and issuing a receipt are arranged in the main body 2.

Further, the camera C5 consisting of, for example, a CCD image sensor is arranged above the side of the display surface of the display section 19 for customer of the POS terminal 1. The camera C5 captures the image of a customer H substantially directly facing the POS terminal 1, centering on the face of the customer H.

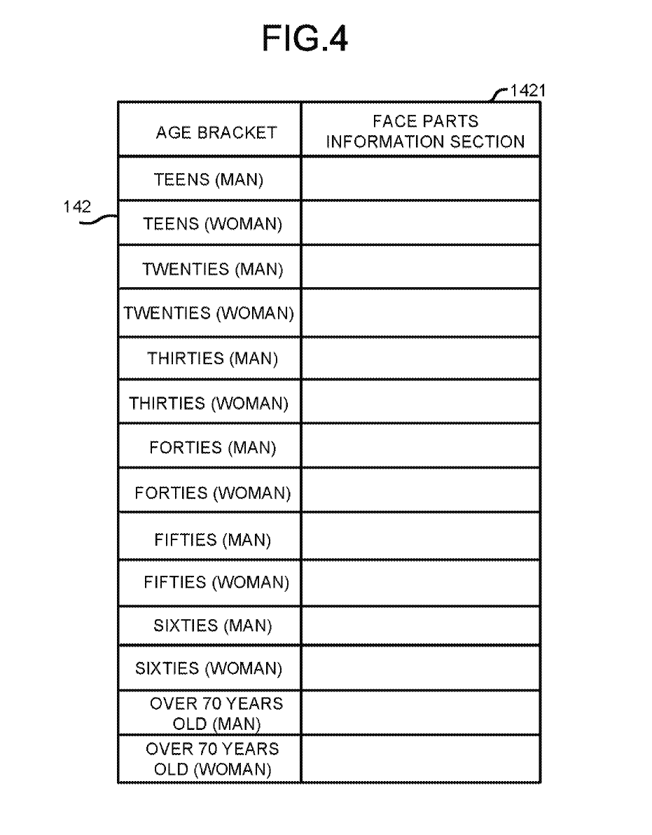

Next, the hardware of the POS terminal 1 is described below with reference to FIG. 3 and FIG. 4. FIG. 3 is a block diagram illustrating the hardware structure of the POS terminal 1. As shown in FIG. 3, the POS terminal 1 comprises a CPU (Central Processing Unit) 11, a ROM (Read Only Memory) 12, a RAM (Random Access Memory) 13 and a memory section 14. The CPU 11 acts as a main part of control. The ROM 12 stores various programs. The RAM 13 copies or decompresses programs and various data. The memory section 14 stores various programs. The CPU 11, the ROM 12, the RAM 13 and the memory section 14 are connected with each other via a data bus line 15. The CPU 11, the ROM 12 and the RAM 13 constitute a control section 100. That is, the control section 100 causes the CPU 11 to operate according to a control program 141 stored in the ROM 12 or the memory section 14 and copied or decompressed on the RAM 13, thereby carrying out a control processing described later.

The RAM 13 includes a commodity information section 131, an image storage section 132 and an image information section 133. The commodity information section 131 stores the commodity information (the name, the price of the commodity, etc.) of a commodity to which a sales registration processing is carried out corresponding to a commodity code read by the reading section 20. The image storage section 132 stores the image of the customer H whose face is detected according to the image captured by the camera C5. The face of a person is detected with the use of a well-known face detection technology which detects a human face by detecting each part (eyes, nose, mouth, ears and jaw) of a face described later according to the image captured by the camera C5. The image information section 133 stores the captured image of the customer H captured by the camera C5. The captured image stored in the image information section 133 refers to an image (for example, an image captured when the face of the customer H does not face the front of the camera C5 directly, or an image captured when the customer H wears sunglasses or a mask) representing an image by means of which a face of the customer H is not detected. Thus, there is a case in which though not all parts of the face are reflected in the captured image stored in the image information section 133, some parts of the face of the customer H are reflected in the captured image.

The memory section 14, which consists of a non-volatile memory such as an HDD (Hard Disc Drive) or a flash memory in which storage information is held even if power is cut off, stores programs containing the control program 141. Further, the memory section 14 includes a face master file 142 (refer to FIG. 4) and an attribute totalization section 143.

The attribute totalization section 143 totalizes the commodity information of a commodity (that is, a commodity purchased by the customer) to which the sales registration processing is carried out by the POS terminal 1 in association with the attribute information of the customer who purchases the commodity by attributes (e.g. gender and age bracket) and stores them. The tendency or the trend of customers to purchase commodities with different attributes can be analyzed according to the commodity information stored in the attribute totalization section 143.

Further, the operation section 17, the display section 18 for store clerk, the display section 19 for customer, the reading section 20, the printing section 21 and the camera C5 are connected with the data bus line 15 via a controller 16. The controller 16 controls the operation section 17, the display section 18 for store clerk, the display section 19 for customer, the reading section 20, the printing section 21 and the camera C5 according to instructions received from the control section 100. For the convenience of description, the control carried out by the controller 16 is described as that carried out by the control section 100.

The operation section 17 includes various keys containing numeric keys and function keys. A ‘subtotal’ key is operated to end the sales registration processing of the purchased commodities and declare the start of a settlement processing. A transaction starts to be settled if the ‘subtotal’ key is operated. A ‘deposit/cash total’ key 171 is operated to declare the end of a transaction and settle the transaction with cash. A cash-based settlement processing is carried out if the ‘deposit/cash total’ key 171 is operated.

The display section 18 for store clerk is arranged with the display surface thereof facing the operator (e.g. a store clerk) so as to display information to the operator. The display section 19 for customer is arranged with the display surface thereof facing the customer H so as to display information to the customer H. Further, touch keys (not shown) arranged on the display section 18 for store clerk and the display section 19 for the customer to touch to play a role of keys constitute a part of the operation section 17.

The reading section 20 consisting of a CCD image sensor inputs the commodity code by reading the codesymbol, for example, the barcode or the two-dimensional code, attached to a commodity with the CCD image sensor. In the embodiment, a store clerk closes or contacts the hand-held reading section 20 to or with the code symbol attached to a commodity to read the code symbol. The reading section 20 may be a scanner which emits light to scan the code symbol with a polygonal mirror and the like and receives the light reflected from the code symbol.

The printing section 21 includes, for example, a thermal printer provided with a thermal transfer type print head. The printing section 21 takes out a rolled receipt paper housed in the main body 2 and prints commodity information and settlement information on the receipt paper to issue the printed paper as a receipt. The camera C5 made up of a CCD or the like captures images of the customer H who executes the transaction. In the embodiment, the camera C5 continuously captures, for example, 10 images of the customer H within one second. The images of the customer captured by the camera C5 also include clothes the customer dresses besides the face.

Further, the data bus line 15 is connected with a communication I/F (Interface) 24 electronically connected with the camera server 4 and a store server (not shown) that are arranged in the office area P2 of the store. The communication I/F 24 is connected with the communication line 5. The store server is electronically connected with each POS terminal 1 arranged in the store to collect commodity information and settlement information from each POS terminal 1. The store server sends the commodity information and settlement information collected from each POS terminal 1 to a headquarters server (not shown) arranged in the headquarters.

FIG. 4 is a memory map illustrating the face master file 142 of the memory section 14. In FIG. 4, the face master file 142 has face parts information sections 1421 in which face parts information of people grouped by age bracket (from teens to over 70 years old) and gender is stored. The face parts information according to which an attribute (age bracket and gender) can be determined is stored in each of the face parts information sections 1421.

The face parts information refers to data, obtained by classifying a face of a person in accordance with parts and features, which indicates each part and feature of each attribute, for example, data representing features of parts containing the eyes, the nose, the mouth, the ears and the jaw of a person and change features of a face containing a smiling face, a solemn face, a face with closed eyes and a face with opened eyes. The face parts information stored by each attribute represents the features of the attribute different from those of the other attributes. For example, in the face parts information section 1421 for boys in their teens, there is stored information containing distinctive eyes, noses, mouths and ears indicating the features of boys in their teens and information containing distinctive smiling faces and distinctive solemn faces indicating the features of boys in their teens. The face parts information stored by the attribute represents the attribute markedly, which is created according to a large amount of statistical data.

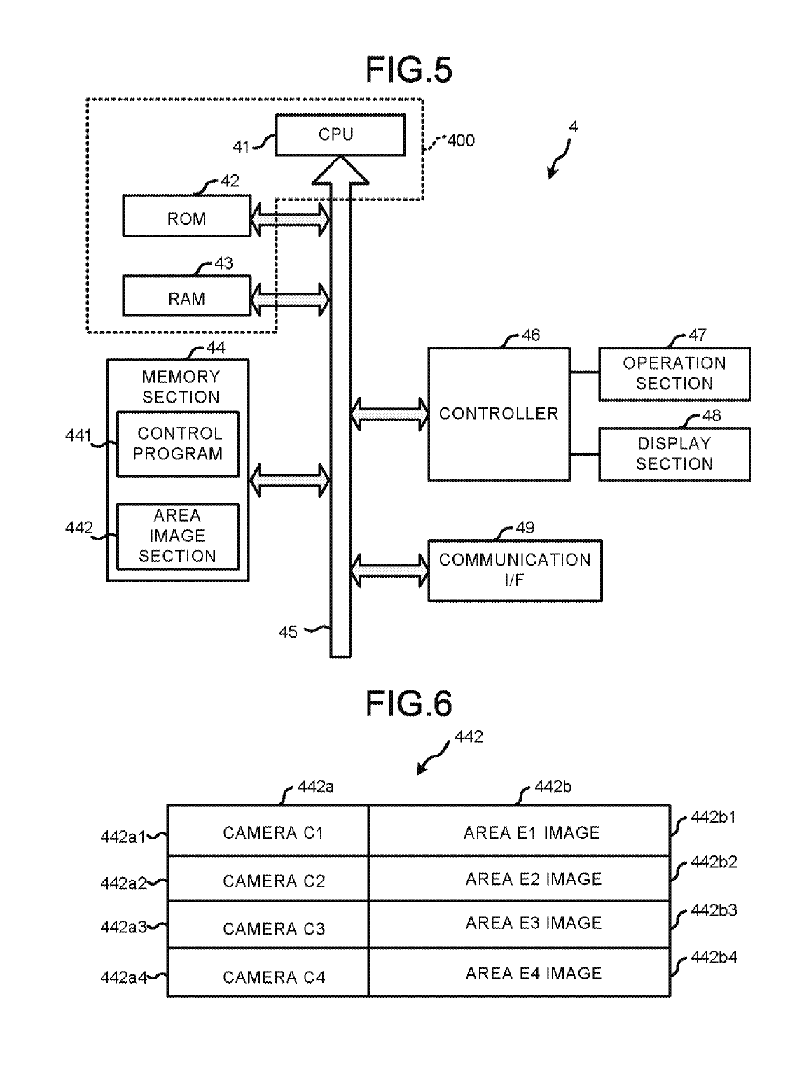

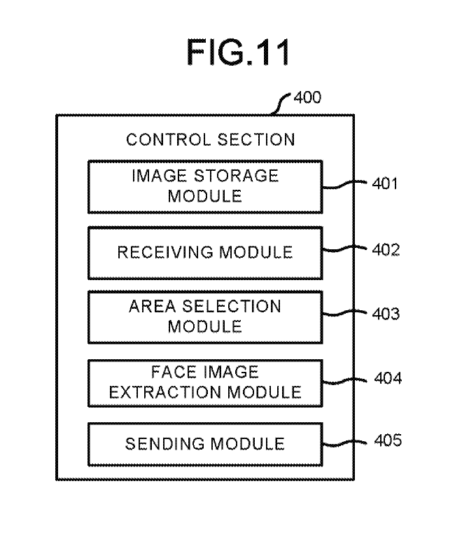

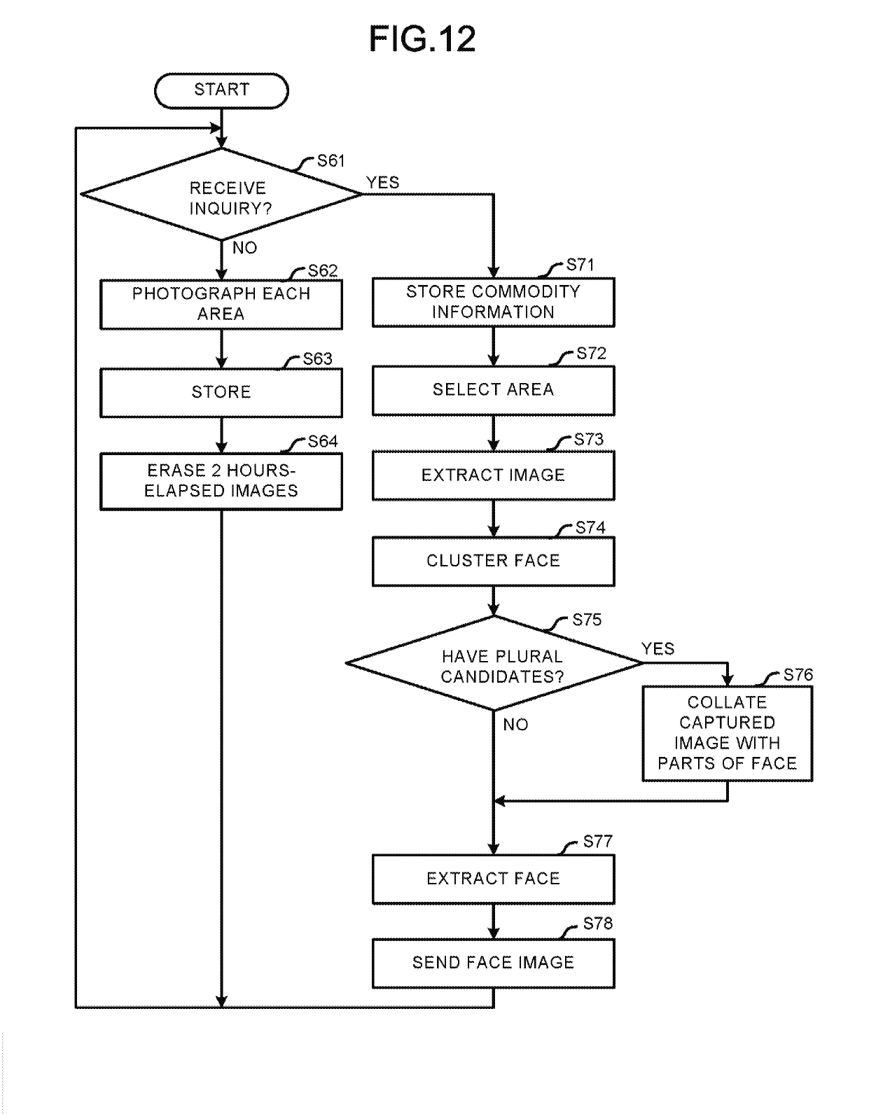

Next, the hardware of the camera server 4 is described with reference to FIG. 5. In FIG. 5, the camera server 4 comprises a CPU 41 acting as a main part of control, a ROM 42 for storing various programs, a RAM 43 for copying or decompressing various data and a memory section 44 for storing various programs. The CPU 41, the ROM 42, the RAM 43 and the memory section 44 are connected with each other via a data bus line 45. The CPU 41, the ROM 42 and the RAM 43 constitute a control section 400. That is, the control section 400 causes the CPU 41 to operate according to a control program 441 stored in the ROM 42 or the memory section 44 and copied or decompressed on the RAM 43, thereby carrying out a control processing (refer to FIG. 11 and FIG. 12) described later.

The memory section 44, which consists of a non-volatile memory such as an HDD (Hard Disc Drive) or a flash memory in which storage information is held even if power is cut off, stores programs including the control program 441. Further, the memory section 44 includes an area image section 442 (refer to FIG. 6).

Further, the data bus line 45 is connected with an operation section 47 and a display section 48 via a controller 46. The operation section 47 is a keyboard equipped with keys for various operations. The display section 48 is, for example, a liquid crystal display device for displaying information. Further, the data bus line 45 is connected with a communication I/F 49. The communication I/F 49 is electrically connected with the POS terminal and the cameras C1-C4 via the communication line 5.

Next, the area image section 442 stored in the memory section 44 is described with reference to FIG. 6. The area image section 442 stores the images of the areas E separately captured by the cameras C1-C4. The area image section 442 includes a camera section 442a that stores a camera code for specifying a camera C used to photograph and an area image section 442b that stores image information of images captured by each camera C. The camera code of the camera C1 is stored in a camera section 442a1, and the images captured by the camera C1 are stored in an area E1 image section 442b1. The camera code of the camera C2 is stored in a camera section 442a2, and the images captured by the camera C2 are stored in an area E2 image section 442b2. The camera code of the camera C3 is stored in a camera section 442a3, and the images captured by the camera C3 are stored in an area E3 image section 442b3. The camera code of the camera C4 is stored in a camera section 442a4, and the images captured by the camera C4 are stored in an area E4 image section 442b4.

Further, in the embodiment, the images captured by the camera C in the last two hours are stored in the area image section 442b and those captured before two hours are successively deleted. Statistically, as most customers complete shopping within two hours, the storage of the images captured by the camera C in the last two hours in the area image section 442b is enough.

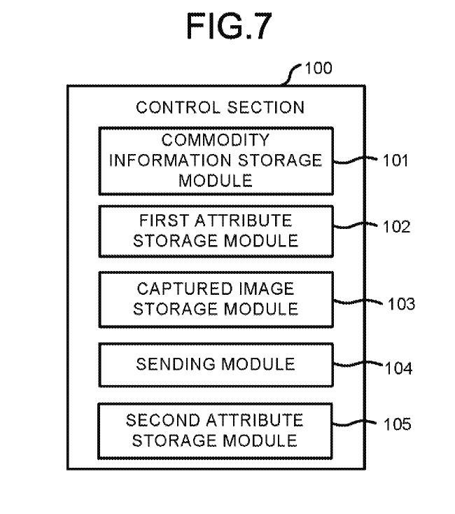

Sequentially, the control processing carried out by the POS terminal 1 is described with reference to FIG. 7-FIG. 10. FIG. 7 is a functional block diagram illustrating the functional components of the POS terminal 1. The control section 100 causes a commodity information storage module 101, a first attribute storage module 102, a captured image storage module 103, a sending module 104 and a second attribute storage module 105 to function according to various programs containing the control program 141 stored in the ROM 12 or the memory section 14.

The commodity information storage module 101 has a function of storing the commodity information of the commodity processed in the transaction in the storage section.

The first attribute storage module 102 has a function of storing, in a case in which the face by means of which the attribute of the customer who purchases the commodity can be determined can be detected according to images captured by a camera, the attribute information indicating the attribute determined according to the face image information of the detected face in the storage section in association with the commodity information.

The captured image storage module 103 has a function of storing the captured images.

The sending module 104 has a function of sending the commodity information stored by the commodity information storage module 101 and the captured images stored by the captured image storage module 103 to the server in a case in which the face by means of which the attribute of the customer who purchases the commodity can be determined cannot be detected according to the images captured by a camera.

The second attribute storage module 105 has a function of storing the attribute information which indicates the attribute determined according to the face image information of the customer sent from the server that extracts a customer according to the sent commodity information and the captured images in the storage section in association with the commodity information.

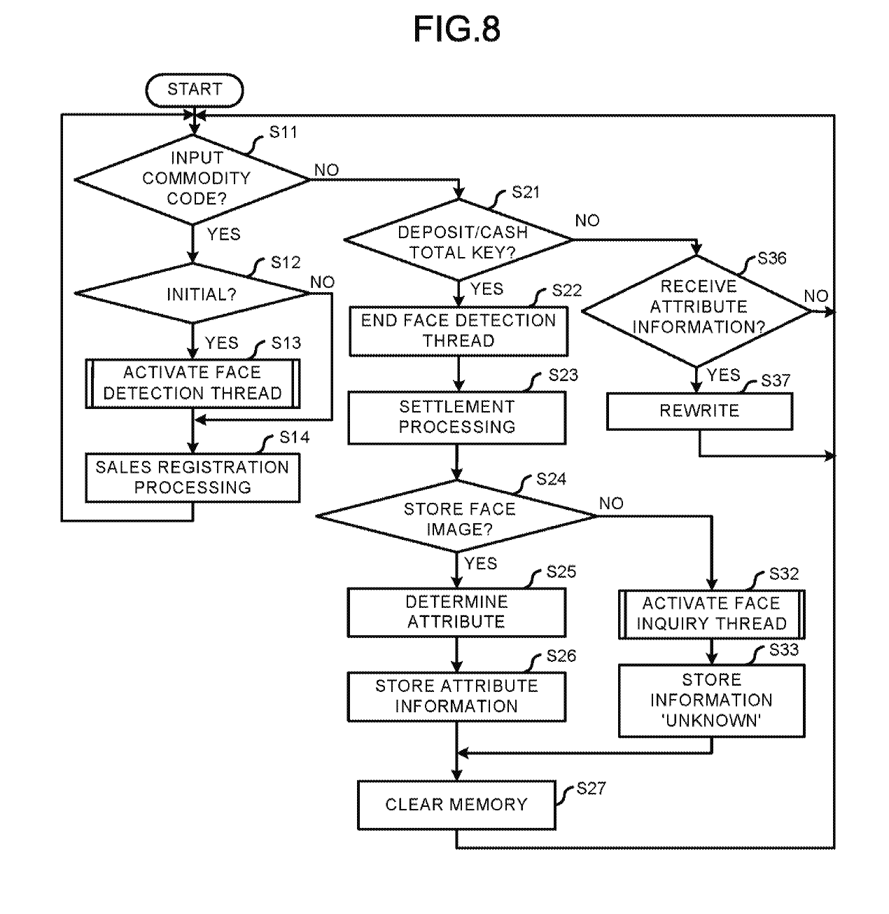

FIG. 8-FIG. 10 are flowcharts illustrating the procedures of a control processing carried out by the POS terminal 1. In FIG. 8, first, the control section 100 determines whether or not the code symbol attached to the commodity is read by the reading section 20 and the commodity code is input (S11). In a case in which it is determined that the commodity code is read (S11: Yes), the control section 100 determines whether or not the commodity code input in S11 is an initially input commodity code of the commodity in the transaction (S12). The control section 100 determines that the commodity code is initially input in the transaction in a case in which the commodity information of the commodity is not stored in the commodity information section 131.

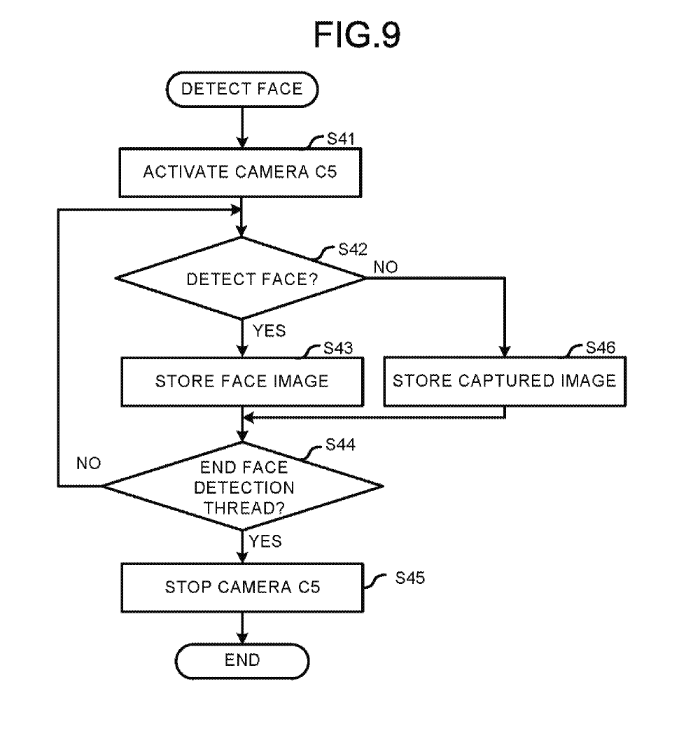

In a case in which it is determined that the commodity code input in S11 is input initially in the transaction (S12: Yes), the control section 100 activates a face detection thread (program) shown in FIG. 9 (S13). Then, the control section 100 (the commodity information storage module 101) executes the sales registration processing of the commodity the commodity code of which is input in Si? and then stores the commodity information in the commodity information section 131 (S14). On the other hand, in a case in which it is determined that the commodity code input in S11 is not input initially in the transaction (S12: No), as the face detection thread is activated already, the control section 100 carries out the processing in S14 but not the processing in S13. Then, the control section 100 returns to the processing in S11.

The procedures of a control processing of the face detection thread activated by the control section 100 in S13 are described with reference to FIG. 9. The face detection thread is a program for capturing the images of the customer H who is standing in front of the display section 19 for customer with the use of the camera C5 arranged on the POS terminal 1 and detecting the face according to the captured images.

In FIG. 9, the control section 100 activates the camera C5 to start to capture images (S41). Then, the control section 100 determines, with the use of the foregoing face detection technology, whether or not a face is detected according to the images captured by the camera C5 of the customer who executes the transaction (S42). In a case in which it is determined that the face is detected (S42: Yes), the control section 100 stores the face image of the customer whose face is detected and who executes the transaction in the image storage section 132 (S43). On the other hand, in a case in which it is determined that the face is not detected (S42: No), the control section 100 (the captured image storage module 103) stores the images of the customer photographed by the camera C5 and who executes the transaction in the image information section 133 (S46).

After the processing in S43 or that in S46, the control section 100 determines whether or not a face detection thread end signal is output by the control section 100 (S44). In a case in which it is determined that the face detection thread end signal is output (S44: Yes), the control section 100 stops the camera C5 to end the photography by the camera C5 (S45).

Further, in a case in which it is determined in S44 that the face detection thread end signal is not output (S44: No), the control section 100 returns to the processing in S42.

Return to FIG. 8, on the other hand, in a case in which it is determined in S11 that no commodity code is input (S11: No), the control section 100 declares the end of the transaction and synchronously determines whether or not the ‘deposit/cash total’ key 171 for settling the transaction with cash is operated (S21). In a case in which it is determined that the ‘deposit/cash total’ key 171 is operated (S21: Yes), the control section 100 outputs an end signal for ending the face detection thread activated in S13 (S22). Then, the control section 100 carries out the settlement processing including processing of the deposit money received from the customer and processing of dispensing the change (S23).

Sequentially, the control section 100 determines whether or not the face image is stored in the image storage section 132 (S24). In a case in which it is determined that the face image is stored in the image storage section 132 (S24: Yes), the control section 100 determines the attribute (e.g. gender and age bracket) of the customer according to the face image stored in the image storage section 132 (S25). In other words, the control section 100 compares each face part (e.g. eyes, nose, mouth, ears and jaw) contained in the face image of the customer stored in the image storage section 132 with the face parts information stored in the face parts information sections 1421 of the face master file 142. Then, the control section 100 determines the attribute of the customer according to the result of the comparison. Specifically, the control section 100 determines the attribute the number of the face parts information of which most similar to those of the face image stored in the image storage section 132 is most. For example, in a case in which the eye information, the nose information, the mouth information and the ear information included in the face parts information of the face image stored in the image storage section 132 are similar to those of men in their forties, even if the jaw information included in the face parts information of the face image stored in the image storage section 132 is similar to that of men in the other age brackets, the control section 100 still determines that the attribute of the customer is a man in his forties.

Next, the control section 100 (the first attribute storage module 102) stores the attribute information corresponding to the attribute determined in S25 in the attribute totalization section 143 in association with the commodity information of the commodity purchased by the customer (S26). Then, the control section 100 clears the information in the commodity information section 131 and the image storage section 132 (S27).

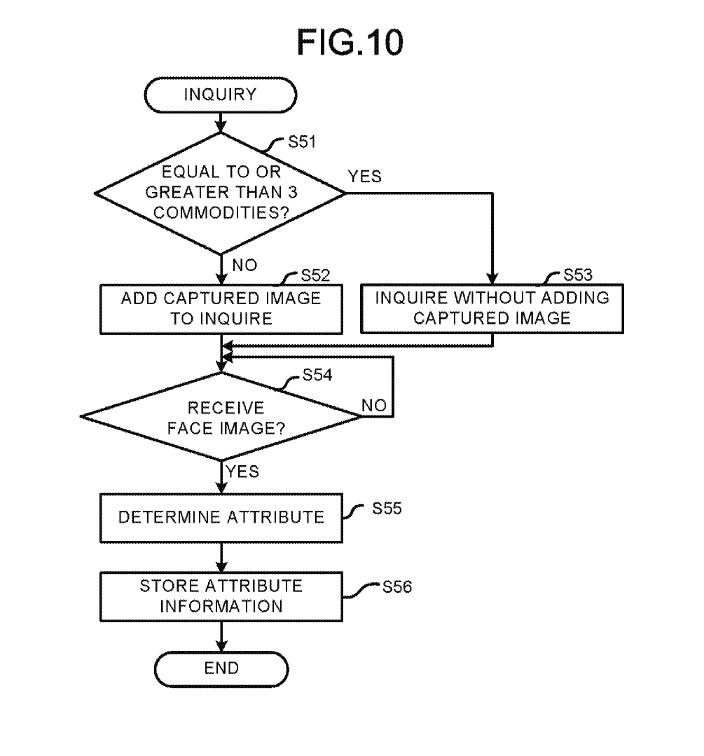

On the other hand, in a case in which it is determined that no face image is stored in the image storage section 132 (S24: No), the control section 100 activates a face inquiry thread shown in FIG. 10 (S32). The details of the face inquiry thread are described in FIG. 10.

Next, the control section 100 totalizes information ‘unknown’ indicating an unknown attribute in the attribute totalization section 143 in association with the commodity information of the commodity purchased by the customer (S33). Then, the control section 100 carries out the processing in S27.

The procedures of a control processing of the face inquiry thread activated by the control section 100 in S32 are described with reference to FIG. 10. The face inquiry thread is a program for inquiring of the camera server 4 about the face image according to the commodity information of the commodity purchased by the customer H and the captured image stored by the image information section 133 and determining the attribute of the customer H according to the face image received from the camera server 4.

The control section 100 (the sending module 104) determines whether the number of the commodities sales-registered in S14 is equal to or greater than 3 or smaller than 3 according to the commodity information and inquiry number acquired in S32 (S51). In a case in which the number of the commodities is smaller than 3 (that is, equal to or smaller than 2) (S51: No), the control section 100 (the sending module 104) sends an inquiry signal added with the commodity information stored in the commodity information section 131, the image capturing information stored in the image information section 133 and the inquiry number to the camera server 4 (S52). In a case in which the number of the commodities is equal to or greater than 3 (S51: Yes), the control section 100 sends an inquiry signal added with the commodity information stored in the commodity information section 131 and the inquiry number to the camera server 4 (S53).

In a case in which the number of the sales-registered commodities is smaller than 3, as the number of the commodities the customer H purchases is less, there is a case in which it is difficult to specify customers who purchase the commodities to one person through the camera server 4. Thus, in a case in which the number of the sales-registered commodities is equal to or greater than 3, by sending the inquiry signal also added with the image capturing information besides the commodity information to the camera server 4, it is easy to specify the customers who purchase the commodities to one person.

After the processing in S52 or S53, the control section 100 determines whether or not the face image is received from the camera server 4 regarding the inquiry (S54). The control section 100 which waits for until the face image is received (S54: No) determines the attribute (e.g. gender and age bracket) of the customer according to the received face image (S55) in a case in which the face image is received (S54: Yes). Next, the control section 100 (the second attribute storage module 105) stores the attribute information of the determined attribute in the attribute totalization section 143 in association with the commodity information of the commodity purchased by the customer instead of the information ‘unknown’ stored in S26 (S56). Then, the control section 100 ends the processing.

Return to FIG. 8, in a case in which it is determined in S21 that the ‘deposit/cash total’ key 171 is not operated (S21: No), the control section 100 determines whether or not the attribute information of the attribute determined according to the face image received from the camera server 4 is acquired by the face inquiry thread (S36). In a case in which it is determined that the attribute information of the attribute is acquired (S36: Yes), the control section 100 rewrites the information ‘unknown’ stored in the attribute totalization section 143 in S33 with the acquired attribute information (S37), that is, stores the attribute of the commodity the attribute of which was previously unknown. Then, the control section 100 returns to the processing in S11. Further, in a case in which it is determined that the attribute information of the attribute determined according to the face image received from the camera server 4 is not acquired (S36: No), the control section 100 returns to the processing in S11.

In the embodiment, the control section 100 stores the information ‘unknown’ indicating that the attribute is unknown in a case in which the face of the customer cannot be detected. Then, the control section 100 sends the commodity information of the commodities purchased by the customer H, the captured image and the inquiry number to the camera server 4 and inquires of the camera server 4 about a face image. Then, the control section 100 receives the face image information of a customer in response to the inquiry. Then, the control section 100 determines the attribute of the customer according to the received face image information, replaces the information ‘unknown’ with the attribute information indicating the determined attribute and stores the attribute information. Thus, the POS terminal 1 can acquire the attribute information of the customer more surely according to the face image information received from the camera server 4 even if the face of the customer cannot be detected and the attribute information of the customer cannot be acquired. As a result, clientele and sales of commodities can be accurately analyzed based on the commodity information of the sold commodity.

Further, in a case in which the number of the purchased commodities is smaller than 3 (that is, the number of the purchased commodities is less), there are many customers who purchase all the commodities. Thus, as it is difficult for the camera server 4 to extract the face image of a customer in some cases, the control section 100 adds the captured image to inquire the camera server 4. On the other hand, in a case in which the number of the purchased commodities is equal to or greater than 3 (that is, there are many purchased commodities), as the customers who purchase all the commodities are limited and it is easy for the camera server 4 to extract the face image of a customer, the control section 100 does not add the captured image at the time of the inquiry operation. Therefore, no excessive burden is applied to the POS terminal 1.

Next, a control processing carried out by the camera server 4 is described with reference to FIG. 11-FIG. 13. FIG. 11 is a functional block diagram illustrating the functional components of the camera server 4. The control section 400 causes an image storage module 401, an receiving module 402, an area selection module 403, a face image extraction module 404 and a sending module 405 to function according to various programs including the control program 441 stored in the ROM 42 or the memory section 44.

The image storage module 401 has a function of storing image information of customers who pass through the areas obtained by photographing the customers through the cameras respectively installed in a plurality of the commodity display areas.

The receiving module 402 has a function of receiving the commodity information of the commodity processed by the POS terminal 1 in the transaction and the image capturing information obtained by photographing the customer who purchases the commodity.

The area selection module 403 has a function of selecting each area stored in the storage section in which the received commodity information is stored.

The face image extraction module 404 has a function of extracting the face image information of a customer photographed in most areas according to the face image and the captured image of the person photographed in the area identified according to the image information of the selected area.

The sending module 405 has a function of sending the extracted face image information to the POS terminal 1.

FIG. 12 is a flowchart illustrating the flow of a control processing carried out by the camera server 4. In FIG. 12, the control section 400 determines whether or not the inquiry signal is sent from the POS terminal 1 along with the execution of the processing in S51 (S61). In a case in which it is determined that no inquiry signal is sent (S61: No), the control section 400 activates the cameras C1-C4 to capture images of the customers who pass through the areas E (S62) Then, the control section 400 (the image storage module 401) stores the captured images in the area image section 442 (S63). Next, the control section 400 erases the previous images captured before two hours within the images stored in the area image section 442 (S64). Next, the control section 400 returns to the processing in S61.

On the other hand, in a case in which it is determined that the inquiry signal is sent from the POS terminal 1 (S61: Yes) and in a case in which the inquiry signal is that in S52, the control section 400 (the receiving module 402) stores the commodity information, the captured image and the inquiry number received together with the inquiry signal in the RAM 43 (S71). Further, in a case in which the inquiry signal is that in S53, the control section 400 stores the received commodity information and the inquiry number in the RAM 43 (S71).

The control section 400 selects an area E regarded as being passed through by a customer H according to the stored commodity information. In other words, the control section 400 specifies a commodity according to the commodity information stored in the RAM 43. The control section 400 (the area selection module 403) selects an area E where the shelf S on which the specified commodity is displayed is arranged (S72). For example, it is assumed that a commodity A and a commodity B are purchased by the customer H and commodity information of the commodity A and the commodity B is contained in the commodity information stored in S71. In this case, the customer H at least passes through the area E1 where the shelf S1 on which the commodity A is displayed is arranged and an area E3 where the shelf S3 on which the commodity B is displayed is arranged. Thus, the control section 400 selects the areas E1 and E3.

Next, the control section 400 extracts, from the area image section 442b, the images captured by the cameras C which photograph the selected areas E (S73). That is, the control section 400 extracts, from the area E1 image section 442b1, the images captured by the camera C1 which photographs the selected area E1. Further, the control section 400 extracts the images captured by the camera C3 which photographs the selected area E3 from the area E3 image section 442b3.

Then, the control section 400 recognizes each human face by carrying out a face recognition processing for the face images contained in the extracted images and gathers (clusters) the face images of the same person commonly photographed in the areas E1 and E3 (S74). The face recognition processing refers to a processing of recognizing a human face according to the captured images with the use of a well-known face recognition technology. The control section 400 carries out the face recognition processing for all faces reflected in the images captured in the extracted areas E1 and E3. The control section 400 clusters all or a plurality of images captured in the areas E1 and E3 or the face images of the same customer captured in the plural areas on the basis of the face images to which the face recognition processing is carried out.

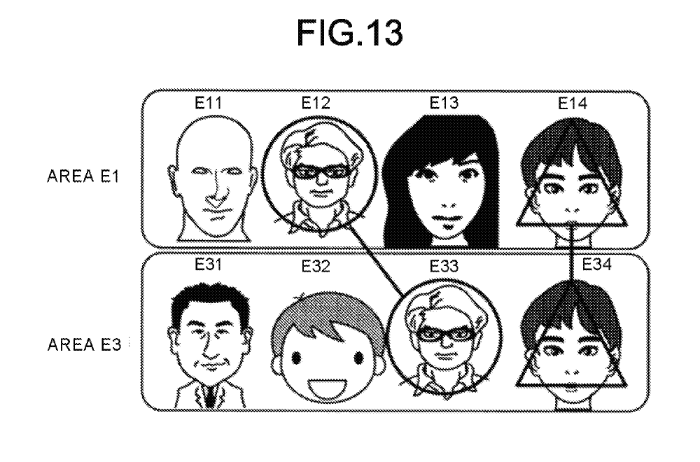

The clustering of the face images is described with reference to FIG. 13. In FIG. 13, face images (E11, E12, E13 and E14) of four customers are captured in the area E1. Face images (E31, E32, E33 and E34) of four customers are captured in the area E3. According to the result of the face recognition processing on each face image, the face image E12 in the area E1 and the face image E33 in the area E3 are recognized to be the face images of the same customer, and thus the face images E12 and E33 (collectively referred to as “face image group A”) are clustered. Further, the face image E14 in the area E1 and the face image E34 in the area E3 are recognized to be the same face image, and thus, the face images E14 and E34 (collectively referred to as “face image group B”) are clustered.

Next, the control section 400 (the face image extraction module 404) determines whether or not the captured images are stored in the RAM 43 and there are plural customers H photographed in the most areas E according to the number of the face images of the face image group A and the number of the face images of the face image group B (in addition, further including the number of face images of a face image group in a case in which the face image group clustered exists) (S75). In a case in which the captured images are stored and there are the plural customers H photographed in the most areas E (S75: Yes), the control section 400 collates each of the face images of the groups A and B with the captured images stored in the RAM 43 (S76). In other words, the control section 400 collates parts of the face images of the groups A and B with the parts of the face of the customer H contained in the captured images. Then, the control section 400 extracts a face image of a group containing the most parts of the matching face as the face image of a customer captured in the most areas E (S77). The processing in S76 and that in S77 are described with the use of the example of FIG. 13.

In the example of FIG. 13, the face image group A is a common face image clustered. Further, the face image group B is a common face image clustered. The number of common face images of the face image group A and that of common face images of the face image group B both is “2” at most. Thus, the control section 400 collates the parts of the face contained in the face image of the face image group A and that of the face contained in the face image of the face image group B with the parts of the faces contained in the captured images (the collation so far is the processing in S76). Then, the control section 400 extracts a face image of a group (the face image group A in the embodiment) containing most parts of the matching face as the face image of a customer captured in the most areas E (the extraction so far is the processing in S77).

The control section 400 (the sending module 405) sends the face image information of the extracted face image to the POS terminal 1 specified by the received inquiry number (S78). Then, the control section 400 returns to the processing in S61. The POS terminal 1 determines the attribute according to the received face image information. Further, in a case in which it is determined that the customer H the number of the face images of whom is the most is the same person in S75 (S75: No), the control section 400 executes the processing in S77 but not that in S76.

In a case in which no captured image is stored in the RAM 43, even if there are the plural customers H photographed in the most areas E, the control section 400 determines that the result of the determination in S75 is “No”. In this case, the control section 400 selects a customer H according to a predetermined method. As only the images captured in the most recent two hours are stored, if three or more commodities are purchased, it is rare that there are plural customers H the number of the face images of whom is the most after the clustering processing.

According to the embodiment, the control section 400 of the camera server 4 selects areas E according to the commodity information received from the POS terminal 1, identifies face images of a customer H captured in the selected area E and extracts the face image of the customer H captured in the most areas E according to the number of the identified face images and the captured images. There is a high probability that the extracted face image represents the customer who purchases the commodities of which the commodity information is received. Then, the control section 400 sends the face image information of the extracted face image to the POS terminal 1. The POS terminal 1 can determine the attribute according to the received face image information and store the attribute information. Thus, the POS terminal 1 can acquire the attribute information of the customer at a higher probability according to the face image information sent from the camera server 4 even if the face image to which the face detection processing is carried out by the POS terminal 1 cannot be detected and the attribute information of the customer cannot be acquired. In other words, the camera server 4 can remove the result of attribute information ‘unknown’ resulting from non-detection of the face through the POS terminal 1. As a result, the clientele and the sales of commodities can be accurately analyzed based on the commodity information of the sold commodities.

According to the embodiment, in a case in which there are the plural customers H the number of the face images of whom is the most after the clustering processing, the control section 400 collates the parts of the face contained in the clustered face images of the customer H with the parts of the faces contained in the captured images. Then, the control section 400 extracts the face image of the group containing the most parts of the matching face as the face image of a customer captured in the most areas E. Thus, as the face image is collated with the captured images only in a case in which there are the plural customers H the number of the face images of whom is the most after the clustering processing, no excessive burden is applied to the camera server 4.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment, the POS terminal 1 sends the inquiry signal added with the commodity information and the captured image to inquire of the camera server 4 about the face image in a case in which the number of the sales-registered commodities is smaller than 3; however, the face image may also be inquired regardless of the number of the commodities.

Further, in the embodiment, the camera server 4 extracts the face image of a customer captured in the most areas E with reference to the captured images when the number of the customers the number of the face images of whom is the most is the same; however, the face image of a customer captured in the most areas E may also be extracted with reference to the captured images even if the number of the customers the number of the face images of whom is the most is one person. In this way, it is confirmed that a customer photographed in the most areas E is the customer who carries out the commodity transaction and the face image of the customer can be extracted.

Further, the cameras C1-C4 are arranged on the ceiling of the store P in the embodiment, and the camera C5 is arranged on the display section 19 for customer of the POS terminal 1. However, the cameras C1-C4 may be located at any other positions as long as the cameras C1-C4 can capture the face images of the customers who pass through the areas E from the front sides of the customers. Furthermore, the camera C5 may be located at any other position as long as the camera C5 can capture the face images of the customer towards which the display section 19 for customer is displayed from the front side of the customer.

Programs executed by the sales data processing apparatus in the embodiment may be recorded in a computer-readable recording medium such as a CD-ROM, a FD (Flexible Disk), a CD-R, and a DVD (Digital Versatile Disk) in the form of installable or executable file to be provided.

Further, the programs executed by the sales data processing apparatus of the embodiment may be stored in a computer connected with a network such as an Internet and downloaded via the network to be provided. Alternatively, the programs executed by the sales data processing apparatus of the embodiment may be provided or distributed via the network such as the Internet.

Alternatively, the programs executed by the sales data processing apparatus of the embodiment may be incorporated into the ROM to be provided.

What is claimed is:

1. A sales data processing apparatus, comprising:
a commodity information storage module configured to store commodity information of a commodity processed in a transaction in a storage section;
a first attribute storage module configured to store, in a case in which a face by means of which an attribute of a customer who purchases the commodity can be determined can be detected according to images captured by a camera, attribute information indicating the attribute determined according to face image information of the detected face in the storage section in association with the commodity information;
a captured image storage module configured to store the captured images;
a sending module configured to send the commodity information stored by the commodity information storage module and the captured images stored by the captured image storage module to a server in a case in which the face by means of which the attribute of the customer who purchases the commodity can be determined cannot be detected according to the captured images; and
a second attribute storage module configured to store the attribute information indicating the attribute which is determined according to the face image information of the customer sent from the server that extracts a customer according to the sent commodity information and the captured images in the storage section in association with the commodity information.

2. The sales data processing apparatus according to claim 1, wherein
the sending module stores information ‘unknown’ indicating an unknown attribute of the customer in the storage section in a case in which the face by means of which the attribute of the customer who purchases the commodity can be determined cannot be detected according to the captured image; and
the second attribute storage module stores the attribute information indicating the attribute of the customer determined according to the face image information of the customer received from the server, instead of the information “unknown”, in the storage section.

3. A server, comprising:
an image storage module configured to store image information of customers who pass through areas photographed by the cameras respectively installed in a plurality of the commodity display areas;
a storage section configured to store each of the areas in association with commodity information of each commodity displayed in the area;
a receiving module configured to receive the commodity information of the commodity processed by a sales data processing apparatus in a transaction and image capturing information obtained by photographing a customer who purchases the commodity;
an area selection module configured to select each area stored in the storage section containing the received commodity information;
a face image extraction module configured to extract face image information of a customer photographed in most areas according to the captured images and face images of the customer captured in the area identified according to the image information of the selected areas; and
a sending module configured to send the extracted face image information to the sales data processing apparatus.

4. The server according to claim 3, wherein
the face image extraction module extracts face image information of one person photographed in the most areas with the use of the image capturing information in a case in which there are plural customers photographed in the most areas.

5. The server according to claim 3, wherein
the face image extraction module extracts face image information of one customer photographed in the most areas with reference to parts of face and clothes of the customer, contained in the image capturing information, who carries out a commodity transaction.

6. The server according to claim 4, wherein
the face image extraction module extracts face image information of one customer photographed in the most areas with reference to parts of face and clothes of the customer, contained in the image capturing information, who carries out a commodity transaction.

7. A method for acquiring attribute information by a sales data processing apparatus, including:
storing commodity information of a commodity processed in a transaction in a storage section;
storing, in a case in which a face by means of which an attribute of a customer who purchases the commodity can be determined can be detected according to images captured by a camera, attribute information indicating an attribute determined according to face image information of the detected face in the storage section in association with the commodity information;
storing the captured image;
sending the stored commodity information and the stored captured images to a server in a case in which the face by means of which the attribute of the customer who purchases the commodity can be determined cannot be detected according to the captured images; and
storing the attribute information indicating the attribute which is determined according to the face image information of the customer sent from the server that extracts a customer according to the sent commodity information and the captured images in the storage section in association with the commodity information.
